(19) United States
(12) Patent Application Publication
(10) Pub. No.: US 2012/0024175 A1
(43) Pub. Date: Feb. 2, 2012

(54) DEVICE FOR POWDERING PRINTED SHEETS IN A PRINTING PRESS, AND PRINTING PRESS WITH A POWDERING DEVICE

(75) Inventor: CLAUDIUS HAAS, STEINACH (DE)

(73) Assignee: HEIDELBERGER DRUCKMASCHINEN AG, HEIDELBERG (DE)

(21) Appl. No.: 13/191,957

(22) Filed: Jul. 27, 2011

(30) Foreign Application Priority Data
Jul. 29, 2010 (DE) 10 2010 032 644.5

(51) Int. Cl. B41K 1/38

(52) U.S. Cl. 101/335

(57) ABSTRACT

A device for powdering a printed sheet in a printing press is formed with nozzle groups that are arranged in a row and that each are formed with several spray nozzles, each of which emits a powder/air mixture. A respective feed line is connected upstream of the nozzles of each nozzle group. The feed line of the spray nozzles of the respective nozzle group is preceded by a common collective line. Along a defined segment of a given length of the course of the respective collective line, a product of the radius of curvature of the segment and the fourth power of an inner diameter of the respective collective line equals 3.125×10⁻¹⁰ m⁵ at a minimum. In a preferred embodiment, the nozzle groups are nozzle heads.

### CROSS-REFERENCE TO RELATED APPLICATION

This application claims the priority, under 35 U.S.C. §119, of German application DE 10 2010 032 644.5, filed Jul. 29, 2010; the prior application is herewith incorporated by reference in its entirety.

### BACKGROUND OF THE INVENTION

1. Field of the Invention:

The invention lies in the field of printing technology. More specifically, the present invention relates to a device for powdering a printed sheet in a printing press comprising nozzle groups arranged in a row and each including several spray nozzles. Each of the spray nozzles emits a powder/air mixture. A respective feed line is connected upstream of the spray nozzles of the respective nozzle group and a common collective line is connected upstream of the feed lines of the spray nozzles of the respective nozzle group.

U.S. Pat. No. 5,713,285 describes a powdering device in which the nozzle heads are arranged in a row on a bar. Each of the nozzle heads comprises two spray nozzles preceded by a respective feed line which is internal relative to the nozzle head. The two feed lines of the respective nozzle head branch off of an upstream common collective line in a crotch. The collective line is designed as a hose. Each of the nozzle heads is connected to a distributor by its own collective line. The distributor supplies the powder/air mixture to the nozzle heads. Moreover, a compressor is provided to supply the pressurized air required to create the powder/air mix. In the disclosed device, the efficiency of the powder application leaves room for improvement.

U.S. Pat. No. 7,607,391 B2 and its counterpart German published patent application DE 10 2004 057 478 A1 describe a powdering device in which each of the nozzle heads comprises three spray nozzles with diverging spraying directions.

Commonly assigned U.S. Pat. No. 6,085,654 and its counterpart German published patent application DE 199 01 245 A1 describe a powdering device in which supply lines connected to a respective nozzle head branch off from a distributor.

### SUMMARY OF THE INVENTION

It is accordingly an object of the invention to provide a powdering device for powdering sheets of a printing press which overcome the above-mentioned disadvantages of the heretofore-known devices and methods of this general type and which provides for a device for powdering a printed sheet in which a high degree of efficiency of the powder application is ensured.

With the foregoing and other objects in view there is provided, in accordance with the invention, a device for powdering printed sheets in a printing press, the device comprising:

a plurality of nozzle groups disposed in a row and each having a plurality of spray nozzles configured to eject a powder/air mixture;

a feed line connected upstream of each of said spray nozzles for feeding the powder/air mixture to each respective spray nozzle;

a common collective line connected upstream of said feed lines of said spray nozzles of the respective said nozzle group;

said common collective line having an inner diameter and extending along a determined course with a segment thereof having a given radius of curvature; and

wherein, in said segment of the course of the respective said collective line, a product of said given radius of curvature and a fourth power of said inner diameter of said collective line equals at least 3.125×10⁻¹⁰ m⁵.

In other words, the objects of the invention are achieved with a device for powdering a printed sheet in a printing press comprises nozzle groups arranged in a row, each group including several spray nozzles, each of which emits a powder/air mixture. A respective feed line is connected upstream of the spray nozzles of the respective nozzle group and is preceded by a common collective line. Within a given distance of the course of the respective collective line, a product of a radius of curvature of the course of the respective collective line and the fourth power of an inner diameter of the respective collective line equals at least 3.125×10⁻¹⁰ m⁵.

The degree of efficiency of such a device is very high. In such a device, the number of powder particles applied to the sheet per unit of surface area is particularly high. The pressure of the pressurized air used to create the powder/air mixture does not need to be increased to increase the degree of efficiency. Thus a comparatively low-cost air compressor can be used.

In accordance with a further development of the invention each group of spray nozzles that emit the powder/air mixture comprises at least three spray nozzles.

In accordance with another development of the invention the collective lines of the nozzle groups branch off of a common distributor or manifold.

In accordance with yet another development of the invention, the defined distance of the course of the respective collective line equals at least twenty times the inner diameter of the respective collective line.

In accordance with again a further development, the spray nozzles of the respective nozzle group have mutually parallel spraying directions.

In accordance with yet another further development, the central axes of the feed lines of the respective nozzle group are aligned to be parallel to a central axis of the common collective line of these feed lines as viewed in the direction of travel of the sheet. In accordance with this feature, the feed lines of the respective nozzle group may be arranged internally with respect to this nozzle group.

In accordance with yet another further development, the central axes of the feed lines of the respective nozzle group are arranged at an angle relative to a central axis of the common collective line of these feed lines as viewed in the direction of travel of the printed sheet. In accordance with this feature, the feed lines of the respective nozzle group may be arranged externally with respect to this nozzle group.

In accordance with a concomitant feature of the invention, the nozzle groups are formed as nozzle heads. The nozzle heads may be fixed to a supporting cross bar such as a hollow profile.

The invention also relates to a printing press that is equipped with a device for powdering a printed sheet in accordance with the invention as outlined above or in accordance with one of the further developments.

Other features which are considered as characteristic for the invention are set forth in the appended claims.

Although the invention is illustrated and described herein as embodied in a device for powdering a printed sheet in a printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 illustrates a powder device including nozzle heads arranged in a row;

FIG. 2 illustrates the connections of the nozzle heads of FIG. 1 with a manifold based on an exemplary nozzle head;

FIGS. 3 and 4 illustrate different views of a first exemplary embodiment of the nozzle head of FIG. 2; and

FIGS. 5 and 6 illustrate different views of a second exemplary embodiment of the nozzle head of FIG. 2.

### DETAILED DESCRIPTION OF THE INVENTION

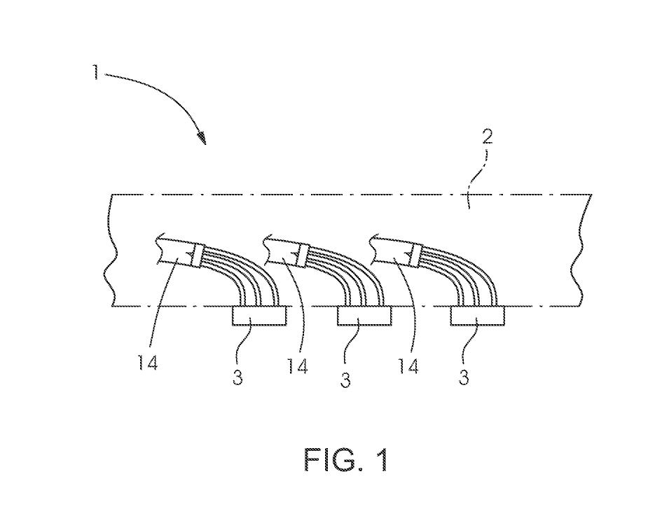

Referring now to the figures of the drawing in detail and first, particularly, to FIG. 1 thereof, there is shown a section of a printing press 1. The illustrated section is an elevational view of a powdering device arranged in a sheet delivery of the printing press 1. The powdering device is used to powder the printed sheets that have been freshly printed in the press 1. The powdering device comprises a cross bar 2 extending over the entire printing width and carrying nozzle heads 3 of identical construction. The nozzle heads 3 may also be referred to as nozzle groups. The nozzle heads are arranged in a row and have nozzle openings that emit a powder/air mixture in a direction perpendicular to the plane of FIG. 1. The nozzle openings of each nozzle head 3 are supplied with a powder/air mixture by a respective system of lines 14. The structure of the line system 14 will be explained in more detail below.

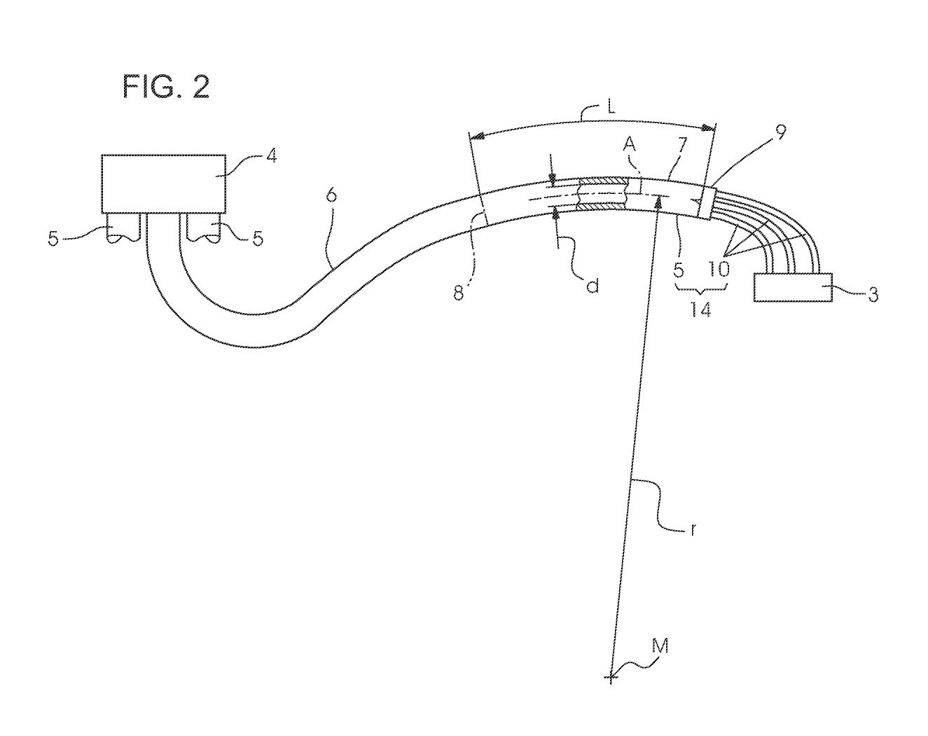

FIG. 2 illustrates a manifold 4 for distributing the powder/air mixture to several collective lines 5 each of which leads to a different one of the nozzle heads 3. The respective collective line 5 may be designed as a tube or preferably as a flexible, bendable hose. It includes a first section 6 and a second section 7. The first section is closer to the manifold 4 and is longer than the second section 7. The length of the second section 7 is described as a segment L whose length amounts to at least twenty times an inner diameter d of the collective line 5. The inner diameter d ranges between a minimum of 5 mm and a maximum of 50 mm. In a preferred embodiment, the inner diameter d is approximately 20 mm (approximately 0.8 inches) and thus the segment L is at least approximately 400 mm (approximately 16 inches). The segment L is limited on one end by the end 8 of the first section 6 and on the other end by a fork 9. The second section 7 immediately follows the end 8 of the first section 6 and has a curvature that is less pronounced than the curvature of the first section 6 and may, in extreme cases, even be straight. The magnitude of a radius r of curvature of the collective line 5 may vary along the segment L but may not drop below 0.5 meters. The radius r of curvature starts in an imaginary center M of the curvature and ends at a central longitudinal axis A of the collective line 5. The center M is located outside the collective line 5.

In the fork 9, the system of lines 14 located between the manifold 4 and the respective nozzle head 3 splits into several feed lines, in the given example into three feed lines 10, each of which leads to a different spray nozzle of a nozzle head 3 in question. The fork 9 may be referred to as a distributor fitting and is inserted like a plug into the end of the collective line 5 that is distal to the manifold 4. The fork 9 has an end facing the feed lines 10. In this end, three small non-central bores are formed. A different one of the feed lines 10 is tightly inserted into each of these bores. The other end of the fork 9 has a large central bore which meets the three small bores. Due to the transition between the large bore and a small bore the flow cross-section changes at least once between the manifold 4 and the nozzle head 3, even if the total cross-section may remain the same. The latter is the case if the flow cross-section of the large bore equals the sum of the flow cross-sections of the small bores. The main volume flow of the powder/air mixture that enters the fork 9 through the large bore is evenly distributed in the fork 9 to provide an identical partial volume flow of the powder/air mixture that exits each of the small bores. The Reynolds number of the collective line 5 and of the second section 7 in particular is at least 2300.

This feature ensures that there are turbulent flow conditions in the collective line 5 and in the second section 7 in particular, advantageously promoting a randomly even distribution of the amount of powder to the feed lines 10.

The fact that the product of the radius r of curvature and the fourth power of the inner diameter d equals at least 3.125×10⁻¹⁰ m⁵ along the segment L immediately upstream of the fork 9 ensures that, unaffected by the turbulences and, in fact, potentially even enhanced by them, the main volume flow is split into partial volume flows of equal magnitude. Thus all the spray nozzles of the nozzle head 3 are supplied with equal amounts of powder.

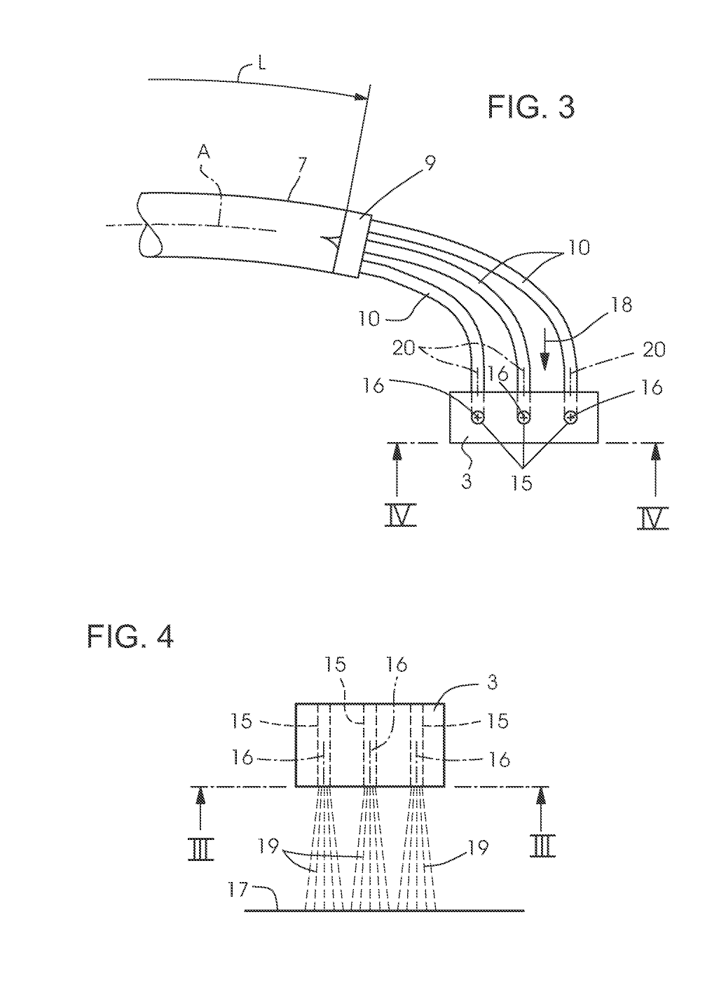

By way of example, FIG. 3 illustrates one of the nozzle heads 3 of FIG. 2 as viewed in a direction III-III in FIG. 4. FIG. 4 illustrates the same nozzle head 3 as viewed in a direction IV-IV in FIG. 3. The nozzle head 3 includes several spray nozzles 15; in the given example, there are three spray nozzles 15, whose spraying directions are mutually parallel or at least substantially parallel. As each of the nozzle heads 3 includes several spray nozzles 15, the nozzle heads 3 may also be referred to as nozzle groups. Accordingly, an angle located between imaginary central axes 16 of nozzle bores or nozzle channels of the spray nozzles 15 is preferable 0°. The central axes 16 of the two outer spray nozzles 15 may diverge slightly, defining an angle not greater than 5°. A non-illustrated transport device, for instance a chain conveyor, moves a printed sheet 17 past the nozzle heads 3 in a direction of travel 18 that is perpendicular to the plane of the drawing of FIG. 4. The direction 18 of travel is indicated symbolically by an arrow in FIG. 3 but not specifically illustrated in FIG. 4. The spray nozzles 15 emit spray jets 19 that widen conically and hit the surface to be powdered of the printed sheet 17 perpendicularly or at least substantially perpendicularly. As can be seen in FIG. 3, the longitudinal axes or central axes 20 of the feed lines 10 are oriented at an angle—preferably a right angle—relative to the longitudinal axis A or central axis A of the collective line 5 to which the aforementioned feed lines 10 are connected by way of the fork 9. For the major part, the feed lines 10 are located outside the nozzle head 3. They may be designed as tubes or, preferably, as flexible, bendable hoses. The central axis 20 of that section of the feed line 10 that is immediately connected to the nozzle head 3 is oriented at an angle—preferably a right angle—relative to the longitudinal or central axis A of the second section of the collective line 5.

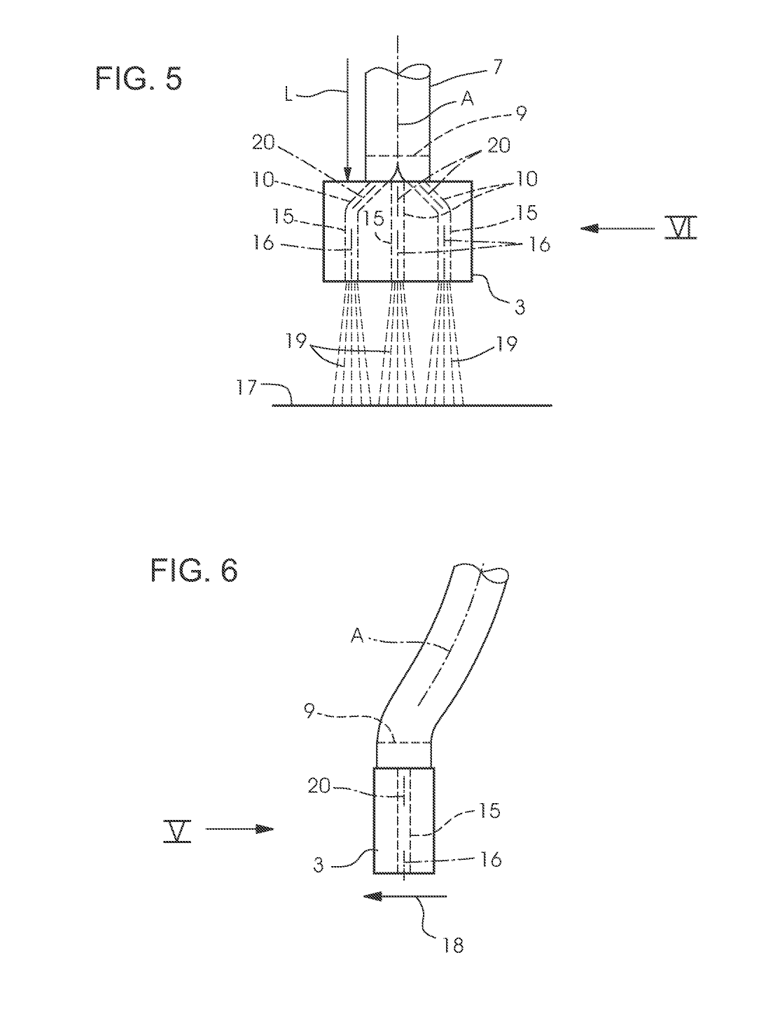

FIG. 5 illustrates one of the nozzle heads 3 of FIG. 2 as viewed in a direction V shown in FIG. 6. FIG. 6, on the other hand, illustrates the same nozzle head 3 as viewed in a direction VI shown in FIG. 5. In this exemplary embodiment, each nozzle head 3 likewise includes a plurality of spray nozzles 15, preferably three spray nozzles 15. The spray nozzles 15 have mutually parallel spraying directions and thus mutually parallel central axes 16. The spraying directions are determined by the nozzle bores or nozzle channels of the spray nozzles 15. The nozzle channels have central axes 16 that are oriented perpendicularly (at a 90° angle) or substantially perpendicularly (90°±2.5°) to the surface to be powdered of the printed sheet 17. The spraying directions of the two outer spray nozzles 15 of the respective nozzle head 3 may diverge towards the printed sheet 17 at an angle of divergence not greater than 5° between the central axes 16 of the two outer nozzles. In FIG. 5, the angle is 0°, i.e. the central axes 16 of the outer nozzles are parallel to each other and parallel to the central axis 16 of the inner nozzle.

In contrast to the exemplary embodiment of FIGS. 3 and 4, the exemplary embodiment illustrated in FIGS. 5 and 6 features feed lines 10 that are integrated into the nozzle head 3. The respective spray nozzle 15 and the feed line 10 corresponding with this spray nozzle 15 form one and the same channel, which may be formed by a single bore in the case of the inner nozzle and by two respective meeting bores in the case of the outer nozzle. The fork 9 is immediately connected to the nozzle head 3 or is formed integrally in one piece with the latter. The central axes 16 of the spray nozzles 15 are oriented perpendicularly to the direction of travel 18 of the printed sheet 17. As viewed in the direction of travel 18 of the printed sheet 17, the central or longitudinal axis A of the second section 7 is oriented at an angle relative to the central axes 20 of the two outer feed lines 10 and the central axis 20 of the central inner feed line 10 is in alignment or parallel.

In accordance with a non-illustrated modification, the nozzles 15 of all the nozzle groups are not formed in nozzle heads attached to the cross bar 2, but are formed in the cross bar 2 itself, which then acts as a so-called spray bar.

1. A device for powdering printed sheets in a printing press, the device comprising:
a plurality of nozzle groups disposed in a row and each having a plurality of spray nozzles configured to eject a powder/air mixture;
a feed line connected upstream of each of said spray nozzles for feeding the powder/air mixture to each respective spray nozzle;
a common collective line connected upstream of said feed lines of said spray nozzles of the respective said nozzle group;
said common collective line having an inner diameter and extending along a determined course with a segment thereof having a given radius of curvature; and
wherein, in said segment of the course of the respective said collective line, a product of said given radius of curvature and a fourth power of said inner diameter of said collective line equals at least 3.125×10⁻¹⁰ m⁵.

2. The powdering device according to claim 1, wherein a number of said spray nozzles for emitting the powder/air mixture per nozzle group is at least three.

3. The powdering device according to claim 1, which comprises a common manifold, with said collective lines of said nozzle groups branching off from said common manifold.

4. The device according to claim 1, wherein a length of said segment of said course of the respective said collective line amounts to at least twenty times said inner diameter of the respective said collective line.

5. The device according to claim 1, wherein said spray nozzles of the respective nozzle group have mutually parallel spraying directions.

6. The device according to claim 1, wherein said feed lines of a respective said nozzle group have central axes aligned to be parallel to a central axis of said common collective line as viewed in a direction of travel of the printed sheets.

7. The device according to claim 6, wherein said feed lines of a respective said nozzle group are arranged internally in said nozzle group.

8. The device according to claim 1, wherein said feed lines of a respective said nozzle group have central axes arranged at an angle relative to a central axis of said common collective line for said feed lines, as viewed in a direction of travel of the printed sheets.

9. The device according to claim 8, wherein said feed lines of the respective said nozzle group are arranged externally with respect to said nozzle group.

10. The device according to claim 1, wherein said nozzle groups are nozzle heads.

11. A printing press, comprising a device according to claim 1 disposed to powder freshly printed sheets.
